(19) United States
(12) Patent Application Publication
(10) Pub. No.: US 2006/0118250 A1
(43) Pub. Date: Jun. 8, 2006

(54) Blind assembly for insulated window

(76) Inventors: Zhe Hao Jin, Shenyang (CN); Ali Y. Li, Diamon Bar, CA (US)

Correspondence Address: PHILIP K. YU, 20955 PATHFINDER ROAD, SUITE 100, DIAMOND BAR, CA, 91765, US

(21) Appl. No.: 11/059,998

(22) Filed: Feb. 16, 2005

Related U.S. Application Data
(60) Provisional application No. 60/632,630, filed on Dec. 2, 2004.

(51) Int. Cl. E06B 3/32

(52) U.S. Cl. 160/107

(57) ABSTRACT

A blind assembly with a combined lifting and tilting control. The blind assembly comprises a pair of glass panels supported by a frame, defining an insulated space; a blind between the glass panels, provided with pull cords for lifting or lowering the blind and ladder cords for tilting the blind; a mechanism disposed in the insulated space, the mechanism has a first controlling part, including a slide that follows said operator and a tilting cord; and a second controlling part including a shaft. The ladder cords and the tilting cord are hung on the shaft, with one end of the tilting cord being fixed to upper side of the slide and the other end being fixed to lower side. The pull cords are routed through the second controlling part and are connected to the slide.

### RELATED APPLICATION

The present application claims priority from provisional applications, Application No. 60/632,630, entitled “Blind Assembly for Insulated Window,” filed on Dec. 2, 2004. The prior application is hereby incorporated into this application by reference as if fully set forth herein.

### BACKGROUND OF THE INVENTION

1. Field of the Invention

The invention generally relates to a blind assembly, and more particularly to a blind assembly used in insulated glass (“IG”) window and methods of operating the same.

2. Description of Related Art

It is well known in the IG art that a double-glazing window provides better insulation than a single-glazing window. It is also known to provide Venetian type blinds or pleated shades between two glass panes. Earlier blinds assemblies for insulated window require a hole to be drilled through one glass pane, in order to facilitate the operation of the control mechanism. This, however, introduces an air passage into the space between the glass panes. To solve this problem, magnetic actuating mechanism is used for controlling the blinds between the insulated panes.

For example, Jelic discloses a tilt mechanism for use on a window blind positioned between double panes of glass in U.S. Pat. No. 5,699,845. The mechanism has a shaft to which the tilt cords are attached. A nut with attached magnet rides on a threaded portion of the shaft and is adjacent the inside surface of one glass pane. A position slide with attached magnet is placed on the outer surface of the glass pane opposite the nut. Movement of the position slide and magnet in one direction moves the nut in the same direction, causing the shaft to rotate. Rotation of the shaft winds and unwinds the tilt cords to open and close the blind.

However, in the conventional blind assemblies, two separate controllers are needed to accomplish the respective actions, i.e. lifting controller and tilting controller. Such separate operations are inconvenient and their structures are complex. Consequently, there is a need for an IG blind assembly in which only one controller is provided to realize both the lifting and the tilting control of the blind.

### SUMMARY OF THE INVENTION

A blind assembly with a combined lifting and tilting control. The blind assembly comprises a pair of glass panels supported by a frame, defining an insulated space; a blind between the glass panels, provided with pull cords for lifting or lowering the blind and ladder cords for tilting the blind; a mechanism disposed in the insulated space, the mechanism has a first controlling part, including a slide that follows said operator and a tilting cord; and a second controlling part including a shaft. The ladder cords and the tilting cord are hung on the shaft, with one end of the tilting cord being fixed to upper side of the slide and the other end being fixed to lower side. The pull cords are routed through the second controlling part and are connected to the slide.

### BRIEF DESCRIPTION OF THE DRAWINGS

The foregoing and/or further objects, features and advantages of the invention will become more apparent from the following description of exemplary embodiments with reference to the accompanying drawings, in which like numerals are used to represent like elements and wherein:

FIG. 1 is an exploded view of a blind assembly according to an embodiment of the invention;

FIG. 2(a) is an enlarged view of the outer slide and the outer guide rail shown in FIG. 1. FIG. 2(b) is a rear view of the outer slide shown in FIG. 2(a).

FIG. 3 is an enlarged view of the horizontal controlling part of the blind assembly shown in FIG. 1, in which the roller supports are partly cutaway to show the route of cords clearly;

FIG. 4 is a perspective view of roller support 30 shown in FIG. 3;

FIG. 5 is a perspective view of roller support 34 shown in FIG. 3; and

FIG. 6(a) is an enlarged view of the vertical controlling part of the blind assembly shown in FIG. 1. FIG. 6(b) is a partly cutaway view of inner slide, which is rotated 90° to show the roller inside more clearly.

### DETAILED DESCRIPTION OF PREFERRED EMBODIMENT

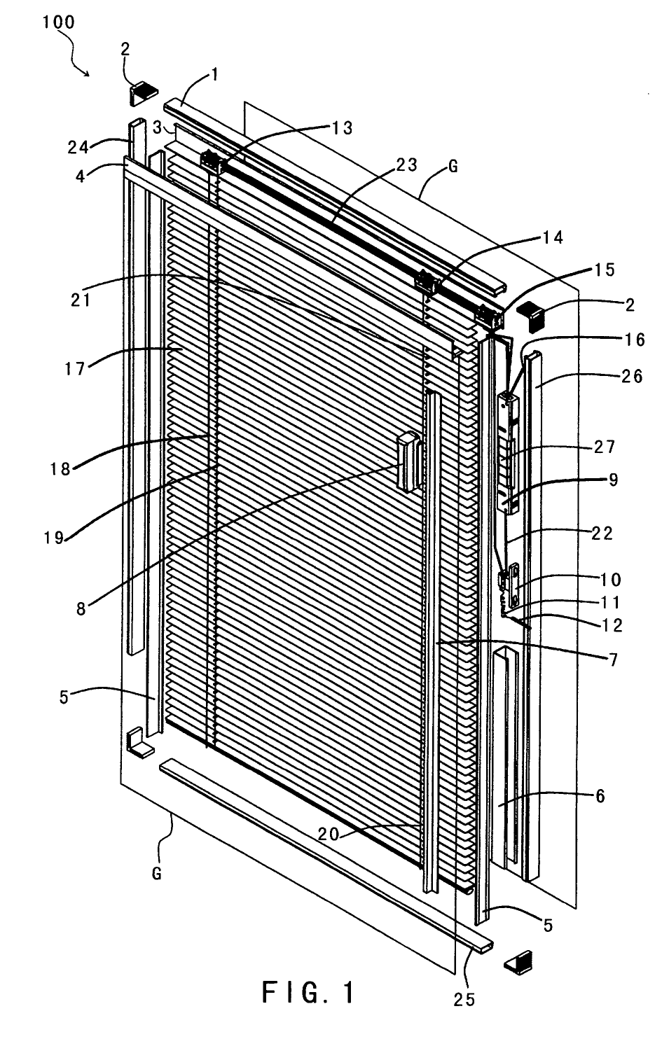

Referring to FIG. 1, the blind assembly 100 according to an embodiment of the invention will be described.

The blind assembly 100 is installed in the insulated space between two glass panels, which are known as double glazing. As shown in FIG. 1, the frame of the blind assembly is generally formed in rectangular shape and includes a cover holder 1, spacers 24 and 25, a rail holder 26, and four corner keys 2. As the general structure of the frame is well known in the art, only a brief description of one example will be given here. The “L-shaped” legs, on which there are many elastic ribs, of the corner keys 2 are inserted into the holders or spacers 1, 24, 25, 26 to form the frame. The holders and spacers may be fastened in other ways. The two glass panels, G, are adhered onto the frame, one on the front surface and the other on the back surface. The glass panels and the frame define an insulated space, in which inert gas may be filled or a desiccant may be deposited for insulation purposes.

The blind consists of a plurality of slats 17 and is suspended on two roller assemblies 13, 14 through ladder cords 18, 20 and pull cords 19, 21. The ladder cords 18, 20 wind around the two sides of the slats 17 and the pull cords 19, 20 extend through the openings near the both ends of the slats 17, as is commonly constructed. The ladder cords, pull cords and tilting cord 22 (to be described later) are all made of the same well-known material, whose frictional coefficient with the rollers is set such that the cords may not skid around the rollers. The roller assemblies 13,14 are mounted on a rear cover 3 and held in position by a front cover 4. Projections on the upper ends of rear cover 3 and front cover 4 are respectively fit into the clasps of the cover holder 1, thereby securing the covers onto it. The cover holder 1, rear cover 3 and front cover 4 are made of such material that is rigid enough to support the weight of the whole blind, but they are not required to be made of the same material. For example, the cover holder 1 and rear cover 3 are made of aluminum, and front cover of PVC.

Control of the blind assembly 100 is jointly achieved by an outer controlling part (comprising outer slide 8 and outer guide rail 7) outside of the glass panel, and an inner controlling part installed in the above-described insulated space. The latter further comprises two parts, i.e. horizontal controlling part (to be described in more detail later) on the top of the blind, and vertical controlling part (to be described in more detail later) on the right side of the blind, which are connected through the cords. In contrast to the conventional methods, in the blind assembly 100 according to the present invention, the lifting and tilting of the blind are combined into a single operation, that is to say, only the outer slide 8 is operated, when a user wants to raise the blind or tilt the slats 17. Then inner slide 9 follows the movement of outer slide 8 under the magnetic interaction between them, thereby driving the horizontal controlling part to lift or tilt the slats 17. The operation methods will be described later.

The vertical controlling part is comprised of an inner slide 9, a roller bracket 10, spring 11, a spring positioning unit 12, a pull cord fixer 16, an inner guide rail 6 and a tilting cord 22. It should be noted that in FIG. 1, the inner guide rail 6 is shown in a cutaway view to show the vertical controlling part more clearly. In the illustrated embodiment, the roller bracket 10 is mounted on a rail holder 26 with fasteners such as bolts. The spring positioning unit 12 and pull cord fixer 16 are bolts which are screwed into the rail holder 26. Other kinds of fasteners are also applicable, as can be appreciated by those skilled in the art. The inner slide 9, roller bracket 10, spring 11, spring positioning unit 12, pull cord fixer 16, and tilting cord 22 are all contained in the inner guide rail 6, which is a hollow elongated U-shaped track. Projections, or flanges, are provided on two sides of the opening of the inner guide rail 6 and extend inwardly. In the same way as the cover 3 and 4 being secured on the cover holder 1, these two projections are respectively fit into the clasps of the rail holder 26, thereby fastening the rail onto it. Following the movement of the magnetic outer slide 8, the inner slide 9 is able to slide along the inner surfaces of the inner guide rail 6.

Opposite to the open side of the inner guide rail 6, an “L-shaped” L-wing 5 is positioned to block the light from leaking into the room through the gaps on the edges of the blind. Another L-wing 5 is provided on the other side (left in FIG. 1) of the blind and positioned onto the inward surface of spacer 24. The longer legs of L-wings 5 are arranged to abut both ends of the slats 17, and the shorter legs are arranged on the side where the light comes in.

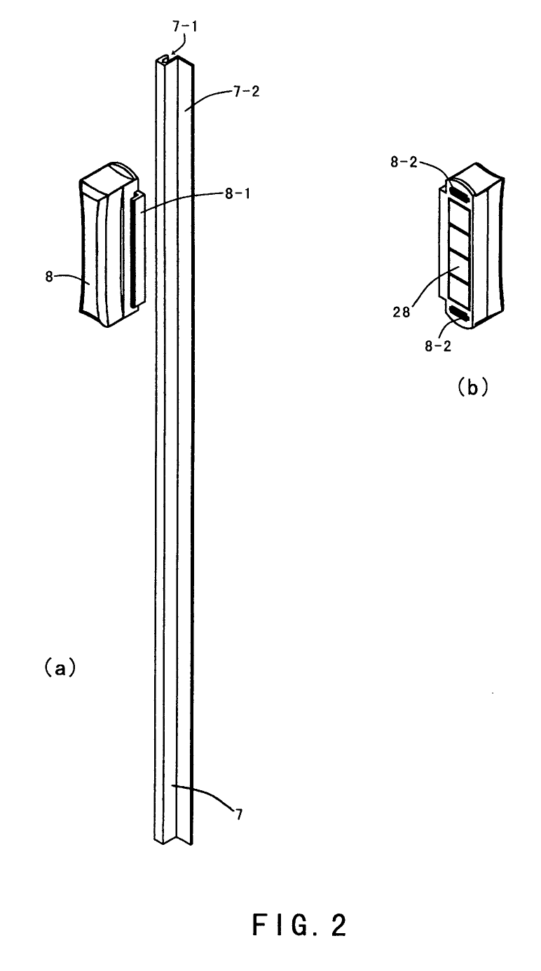

The outer controlling part is described with reference to FIGS. 2(a) and 2(b). In the outer controlling part, the outer slide 8 is guided by an outer guide rail 7 and slides on the glass panel adjacent to the inner guide rail 6. Wheels, or rollers, 8-2 are provided on the surface of the outer slide 8 facing the glass panel, to provide smooth movement by lowering the friction of sliding. A plurality of small magnets 28 are shown to be stacked in the center of the outer slide 8. Thanks to the retention by the outer guide rail 7, the outer slide 8 will not detach from the inner slide 9 even when the user is operating the outer slide 8 too fast. In particular, the outer slide 8 is provided with an “L-shaped” protrusion 8-1 on one side facing the outer guide rail 7. Correspondingly, the outer guide rail 7 is provided with a recess groove 7-1 that is shaped to receive the “L-shaped” protrusion 8-1. Therefore, when the protrusion 8-1 is fitted into the recess groove 7-1, the outer slide 8 can be guided in a desired path. Further, there is a flat extension flange 7-2 on the side away from the outer slide 8 of the outer guide rail 7. With the extension flange 7-2 inserted into the frame and attached on the glass panel, the assembly of the outer slide 8 and the outer guide rail 7 may be applied to any kind of suitable window or door, while keeping the overall esthetics of the window or door.

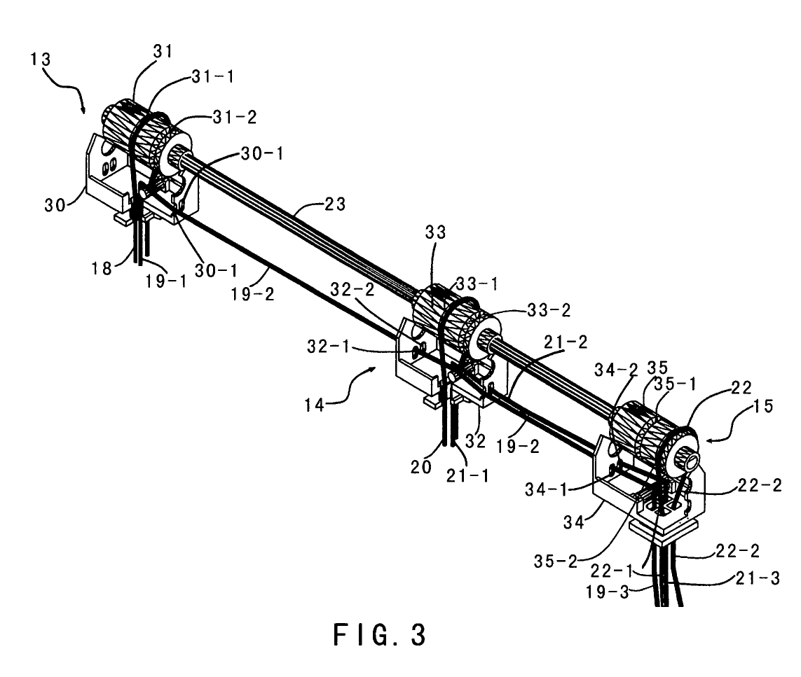

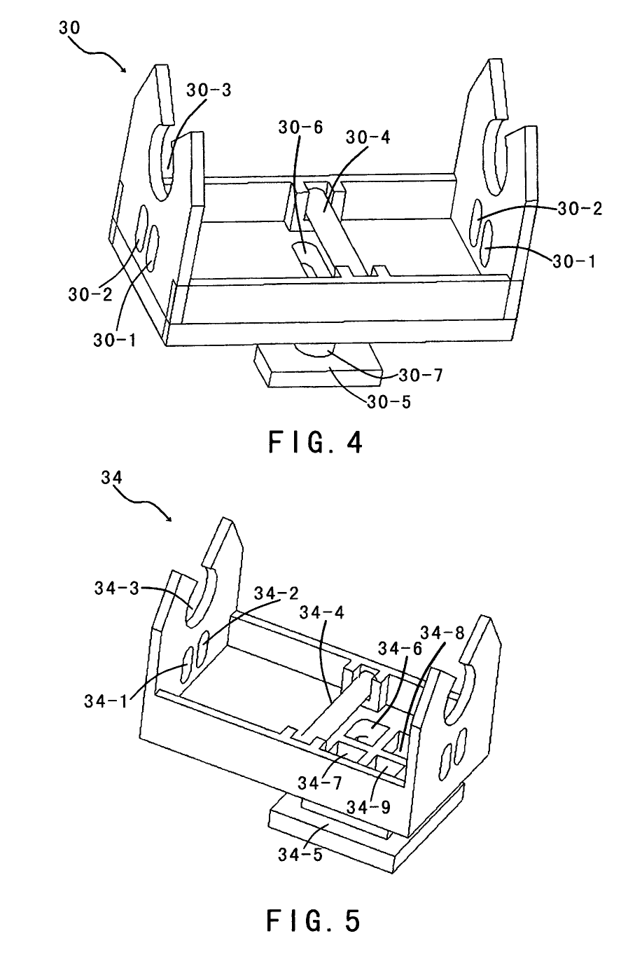

Now the horizontal controlling part will be described with reference to FIGS. 3˜5. FIG. 3 illustrates an enlarged view of the horizontal controlling part of the blind assembly 100 shown in FIG. 1, in which the roller supports are partly cutaway to show the route of cords clearly. FIGS. 4 and 5 are perspective view of the roller support 30 and 34 shown in FIG. 3, respectively.

The horizontal controlling part is comprised of three roller assemblies 13, 14, 15, each of which includes a roller 31, 33, 35 and a roller support 30, 32, 34, respectively. The roller assemblies 13, 14, 15, have a common shaft 23. All the three rollers 31, 33 and 35 are structured the same, and roller supports 30, 32 are structured the same. A roller is formed as a cylinder with two protrusions at the two ends, which are seated in holes 30-3 and rotatably supported by roller support. The roller further includes a through hole, at the roller's protrusions, through which the shaft 23 is inserted. The shaft 23 is tightly fit into the through holes of the rollers 31, 33, 35, once inserted, thereby causing the three rollers 31, 33, 35 to rotate in unison. There are two V-shaped grooves, for winding the ladder cords 18, 20 or tilting cord 22 thereon, on the cylindrical surfaces of every roller.

Next, a detailed description of the roller support 30, 32 will be given with reference to FIG. 4, where the roller support 30 is further described. As shown in FIG. 4, the roller support 30 is provided with a support body and a support seat 30-5 under the support body, which are connected by a connector 30-7. Openings are provided on the horizontal surface of the rear cover 3 and front cover 4 to correspond to the connector 30-7, which is smaller than the support seat 30-5. Therefore, by means of the support seat 30-5 and connector 30-7, the roller 30 is held in position on the rear cover 3 and front cover 4. A cylindrical rotator 30-4 is rotatably provided in the support body. In the bottom surface of the support body, a hole 30-6 is provided under the rotator 30-4, which is offset from the rotator but aligned with the opening in the support seat 30-5 and connector 30-7, thus altogether forming a through passage. Two holes 30-1 and 30-2 are provided abreast on left and right sides of the support body.

Referring to FIG. 5, the structure of roller support 34 is similar to the roller support 30 and 32, except the locations of the holes in the bottom surface and support seat 34-5. Unlike the support seat 30-5 on the left side of the rotator 30-4, the support seat 34-5 is provided on the right side of the rotator 35-4. Moreover, there are four holes provided at the bottom surface of the support body, extending downward and through the support seat 34-5, thus forming a through passage. The left two holes 34-6, 34-7 are used for guiding the pull cords 21, 19 to the vertical controlling part, and the right two holes 34-8, 34-9 are for guiding the tilting cord 22 downward to the vertical controlling part. The roller assembly 15 is mounted onto the rear cover 3 and front cover 4 in the same way as roller assembly 13, 14.

It is to be understood that any reference herein to the “right” side or “left” side should be viewed from the side of the window assembly as illustrated in FIG. 1, where the controlling part is located on the “right” side of the frame. As can be understood, the holes on the bottom surface of the rollers are placed relative to the rotators so that the cords are routed to wherever the controlling part is located. As shown in FIG. 1, the controlling part is on the right side of the frame. As such, the holes on the support 30, 32 are on the “left” of the rotator 30-4, 32-4 (not shown), while the holes on the support 34 are positioned on the “right” of the rotator 34-4. Of course, if the controlling part were on the “left” side, then the positioning of the holes relative to the rotators would be reversed for the direction of the cords.

The tilting of the slats is actuated by the ladder cords 18, 20. As shown in FIG. 3, the ladder cord 18 passes through the hole 30-6 of the support 30, extending upward and being hung on the groove 31-1 of the roller 31. The other ladder cord 20 passes through the hole 32-6 of the roller 30, extending upward and hanging on the groove 33-1 of roller 33. Thus, when the rollers 31, 33 are rotated by the controlling parts, the ladder cords 18, 20 move with the respective roller and the tilting angle of the slats 17 can be adjusted according to the rotation angle of the rollers. In operation, the routes of ladder cords 18, 20 are confined by holes 30-6, 32-6 respectively, thereby stabilizing the tilting adjustment.

Lifting and lowering of the slats 17 are controlled by the pull cords 19. Since they are routed from the bottom of the slats 17, through the horizontal controlling part and to the vertical controlling part, different segments of the pull cords 19 in different parts are referred to as different numerals. For example, the pull cord 19-1 penetrates the centers of the slats 17, passes upward through the hole 30-6 and is wound around the rotator 30-4. Then the pull cord, now labeled as 19-2, is routed through the hole 30-1 on the right sidewall of the roller support 30, the hole 32-1 on the left sidewall of the roller support 32, the hole 32-1 on the right sidewall of roller support 32, and the hole 34-1 on the left sidewall of the roller support 34.

When the pull cord 19-2 is in the roller support 32, the rotator 32-4 (not shown, but similar to the rotator 30-4) is arranged to be in an elevated position than the pull cord 19-2, such that cord is still in some frictional contact with the rotator 32-4. Thus, the pull cord 19-2 is stretched without any slack. At last, the pull cord 19-2 winds around the rotator 34-4 and passes through the hole 34-7, into the vertical controlling part, where the pull cord is now labeled as 19-3.

The route of the other pull cord 21 is parallel with that of the pull cord 19. The pull cord 21-1 passes through the centers of the slats 17, upward through the hole 32-6 and is wound around the rotator 32-4. Then the pull cord, now labeled as 21-2, passes through the hole 32-2 on the right sidewall of roller support 32, and the hole 34-2 on the left sidewall of roller support 34. At last, the pull cord 21-2 is wound around the rotator 34-4 and passes through the hole 34-6, into the vertical controlling part, where the pull cord is now labeled as 21-3. Now the vertical controlling part has two pull cords 19-3 and 21-3, evenly controlling both sides of the slats 17.

The vertical controlling part also has the tilting cord 22 attached to it. The tilting cord 22 is snuggly fit into the groove 35-2 of the roller 35 and passes through the holes 34-8, 34-9, where the tilting cord is now labeled as 22-2, 22-1 respectively. Consequently, four cords go from the horizontal controlling part to the vertical controlling part, two of which are pull cords 19-3, 21-3, the other two 22-1, 22-2 of which are segments of the tilting cord 22.

In contrast to the conventional technology, since the holes 30-1 and 30-2, 32-1 and 32-2, 34-1 and 34-2 are provided side by side and confine the pull cord 19 and 21 in separate routes, the two pull cords will not be twisted in operation and the reliability is enhanced. Furthermore, whenever the pull cords change their direction of routes, a rotator is provided to help them slide more smoothly, further enhancing the reliability. Although in the illustrated embodiment, the pull cord 19 is routed through the holes 30-1, 32-1, 34-1 and 34-7 and pull cord 21 is routed through the holes 30-2, 32-2, 34-2 and 34-6, their arrangement may be interchanged; that is, the pull cord 19 may be routed through the holes 30-2, 32-2, 34-2 and 34-6 and pull cord 21 is routed through the holes 30-1, 32-1, 34-1 and 34-7. As can be appreciated by those skilled in the art, the routing of the cords may be differently arranged based on the customization of their products.

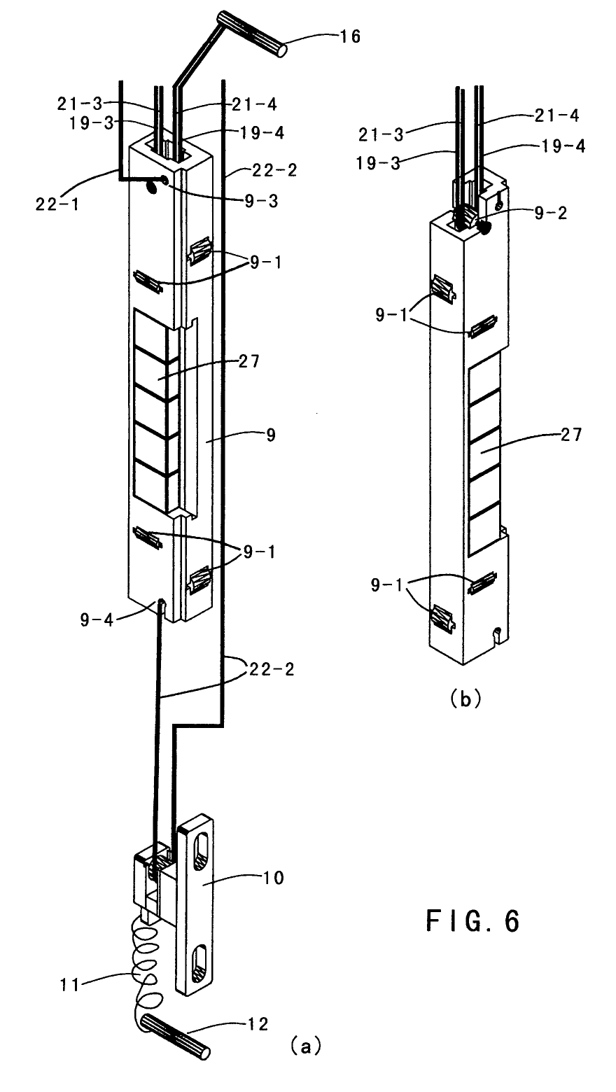

Now the vertical controlling part will be described with reference to FIGS. 6(a) and 6(b). FIG. 6(a) is an enlarged view of the vertical controlling part of the blind assembly shown in FIG. 1. FIG. 6(b) is a partly cutaway view of the inner slide 9, which is horizontally rotated 90° to show the roller inside the cutaway more clearly. As described above, the inner slide 9 is disposed in the inner guide rail 6 and follows the movement of the outer slide 8 due to the magnetic interaction between them. In FIGS. 6(a) and 6(b), a plurality of small magnets 27 are shown to be stacked in the center of the inner slide 9. And magnets 28 are similarly stacked in the outer slide 8 (see FIG. 2(b)). To facilitate the sliding movement of the inner slide 9, two wheels 9-1 are provided on each side surface contacting the guide rail 6. Like the wheels on the outer slide 8, the wheels 9-1 slightly protrude from the side surfaces of the inner slide 9 and contact the inner surfaces of the inner guide rail 6. The roller bracket 10 is mounted on the rail holder 26 with fasteners such as bolts. The spring positioning unit 12 and pull cord fixer 16 are bolts which are screwed into the rail holder 26.

The pull cords 19-3, 21-3, routed from the holes 34-9, 34-8, extend into the inner slide 9. Then they are wound around the roller 9-2 inside the inner slide 9 and extend upward as 19-4, 21-4. In the end, they are anchored onto the pull cord fixer 16, which is attached to the rail holder 26. When the inner slide 9 moves upward or downward, it can be taken as a movable pulley. As is well known by a person skilled in the art, the height variance of the bottom slat of the blind is twice as much as the movement distance of the inner slide 9, which is the same as the movement distance of the outer slide 8. That is to say, when the user slides the outer slide 8 with the distance x, the blind is raised or lowered with the distance 2x. This advantage facilitates the user's operation and reduces the size and required length of the vertical controlling part. Besides, more movable pulley units may be added to obtain higher multiples of the lifting distance over the operating distance. Currently, only one such pulley is used, thus achieving a 2x advantage in lifting distance.

The tilting cord 22 is also actuated by the inner slide 9. One segment 22-1 of the tilting cord 22 goes down from the hole 34-9 and is fixed, or terminated, at the upper part 9-3 of the inner slide 9. The other segment 22-2 goes down from the hole 34-8 and extends to roller bracket 10. Then it is wound around the roller of the roller bracket 10 and extends upward. In the end it is terminated at the lower part 9-4 of the inner slide 9. The segments 22-1, 22-2 and the slide 9 thus form a complete loop. Therefore, when the inner slide 9 moves upward or downward, the tilting cord 22 circulates around the roller on the roller bracket 10. The length of the whole tilting cord 22 and the relative position of roller bracket 10 on the rail holder are appropriately selected, so that when the blind assembly 100 has been assembled and is ready to be used, the tilting cord 22 is stretched appropriately. Thus, as the tilting cord 22 is driven by the movement of the inner slide 9, the static friction between the tilting cord 22 and the roller 35 can bring the roller 35 to rotate along. Then, through the shaft 23, the rollers 31, 33 are rotated together with the roller 35. At last, the ladder cords 18, 20 are driven by the rotation of the rollers 31, 33 to slide. Consequently, the slats 17 are tilted by the simple motion of moving the inner slide 9 up or down.

Additionally, in order to prevent the loosening of the tilting cord 22 after extensive use, a spring 11, or any similar elastic element, is provided to adjust the tension of the tilting cord 22 automatically. The whole roller bracket 10 or the part that projects from the bracket body, is made of a kind of material that is somewhat elastic, and yet rigid enough, to hold the roller at the same time, such as PVC. Thus, if the tilting cord 22 becomes loose, the spring 11, fixed at one end to the rail holder 26, can pull the roller bracket 10 and thereby tighten the tilting cord 22.

Next, the operating methods of the blind assembly 100 will be explained. When a user moves the outer slide 8 downward in the direction defined by the outer guide rail 7, the magnetically-coupled inner slide 9 follows the outer slide 8 and moves downward too. Thus, the inner slide 9 pulls the pull cords 19, 21 down. Since the other ends of the pull cords are fixed on the bottom slat of the blind, the blind is lifted under the control of the outer slide 8. As a result of forming inner slide 9 as a movable pulley, the lifting length of the blind can be twice as long as the operating distance of the outer slide 8. Similarly, when the user moves the outer slide 8 upward by a distance of x, the blind is lowered by an extended distance of 2x.

If a user wants to tilt the slats 17, he or she only has to move the outer slide 8 for a short distance. For example, when the slats 17 are in horizontal position and the user wants to close the slats 17, the user only has to slide the outer slide 8 downward. Magnetically, the inner slide 9 follows the outer slide 8 and moves downward too. The tilting cord 22 is driven to loop around. Because the static friction between tilting cord 22 and roller 35 is large enough, the roller 35 is driven by the tilting cord 22 to rotate. As the shaft 23 connects the rollers 31, 33 and roller 35 together, the rollers 31, 33 start to rotate in unison with the roller 35. Also, the static friction forces between the ladder cords 18, 20 and rollers 31, 33 are large enough to bring the ladder cords 18, 20 to loop at the same time, thereby tilting the slats 17. When the user continues to slide the outer slide 8 downward, the slats 17 are continuously tilted, until reaching the full tilting angle of 90° and the blind is closed. Thereafter, if the user still continues to slide the outer slide 8 downward, though the rollers 31, 33 are still driving the ladder cords 18, 20, due to the well known structure of blind, the slats 17 are unable to be tilted anymore. The forces between the slats 17 and the ladder cords 18, 20 overcome the static friction force between the tilting cord 22 and the roller 35. Thus, the rollers 31, 33 and 35 stop rotating and the tilting cord 22 only slides over the surface of the roller 35.

If the user wants to open the slats 17 again, the user just has to slide the outer slide 8 in the opposite direction, i.e. upward. Similarly, the rollers 31, 33 and 35 are driven to rotate, though in the opposite direction to the rotation when closing the slats 17. Then, the slats 17 begin to return to their original horizontal positions, thereby opening the slats 17. Similarly, when the slats 17 are opened completely, the structure of the blind prevents the further tilting of the slats 17 and the tilting cord 22 begins to slide idly on the roller 35. Although the blind is raised or lowered at the same time in tilting the slats 17, since the required movement of the outer slide 8 is very small, the movement distance of the blind is correspondingly small and inconspicuous.

Therefore, in the blind assembly according to the present invention, the lifting and tilting of the blind are combined into one single operation and actuator. This combination advantageously facilitates the users and simplifies the configuration. The manufacturing cost is also greatly reduced.

Further, the blind assembly according to the present invention may be applied to other blinds, in which other actions than the magnet are used for controlling the movement of the blinds, as long as there are pull cords and ladder cords in these blinds.

While some embodiments of the invention have been described above, for the illustrative purpose only, it is to be understood that the invention is not limited to the details of the illustrated embodiments, but may be embodied with various changes, modifications or improvements, which may occur to those skilled in the art without departing from the spirit and scope of the invention.

What is claimed is:

1. A blind assembly comprising:
a pair of glass panels supported by a frame, defining an insulated space;
a blind between said glass panels, provided with pull cords for lifting or lowering said blind and ladder cords for tilting said blind;
a mechanism disposed in the insulated space to control the lifting and tilting of said blind with one operator outside the insulated space, comprising:
a first controlling part, including a slide that follows said operator and a tilting cord; and
a second controlling part including a shaft,
wherein said ladder cords and said tilting cord are engaged on said shaft, one end of said tilting cord is fixed to upper side of said slide and the other end is fixed to lower side, and said pull cords are routed through the second controlling part and are connected to said slide.

2. The blind assembly of claim 1 wherein said tilting cord is stretched so tight that, when said tilting cord is moved, said tilting cord causes said shaft to rotate accordingly due to the friction between them.

3. The blind assembly of claim 2 wherein the first controlling part further comprises a roller bracket, which is attached to the frame, being provided with a roller, and one of the two ends of said tilting cord is wound around the roller before being fixed to said slide.

4. The blind assembly of claim 3 wherein the first controlling part further comprises a stretcher with elasticity, one end of which is fixed to the roller bracket and the other end is fixed to the frame.

5. The blind assembly of claim 1 wherein said slide further comprises a roller, and said pull cords are wound around the roller and finally fixed to the frame.

6. The blind assembly of claim 1 wherein two L-shaped wings are provided on the two sides of the blind, for preventing the light from leaking in.

7. The blind assembly of claim 1 wherein the second controlling part further comprises a plurality of roller assemblies supporting said shaft.

8. The blind assembly of claim 7 wherein holes are provided on the sides of the plurality of roller assemblies to route the pull cords separately.

9. The blind assembly of claim 1 wherein said operator is guided by a guide rail, one side of which is inserted into the frame and attached on the glass panel.

10. The blind assembly of claim 1 wherein wheels are provided on the surfaces of said operator and said slide to facilitate their sliding.

11. A blind assembly for an insulated window, comprising:
a pair of glass panels supported by a frame, defining an insulated space in-between;
a blind between said glass panels, provided with pull cords for raising or lowering said blind and tilt cords for tilting said blind;
a mechanism disposed in the insulated space to control the lifting and tilting of said blind, comprising:
an operator, positioned outside of said insulated space, disposed to control said pull cords and said tilt cords, said operator having a predefined path of movement;
a spring fixer, having a roller for one of said tilt cords to be rollably engaged to;
a slide magnetically following the movement of said operator, said slide having a roller for said pull cords to be rollably engaged to, said pull cords having its end fixed to a stationary position, said slide also connecting between two ends of said one of said tilt cords, said slide in a first movement controlling said pull cords and in a second movement controlling said tilt cords.

12. A blind assembly of claim 11, wherein:
said mechanism further comprises three rollers having a common shaft, said rollers controllably rotating in unison with said shaft;
said pull cords comprises a first pull cord for pulling a distal end of said blind and a second pull cord for pulling a proximate end of said blind, said first and second pull cords forming a close loop including said roller in said slide;
said tilt cords comprises:
a first tilt cord, disposed to control the tilting of said blind, and looping around a first roller of said three rollers;
a second tilt cord, disposed to control the tilting of said blind, and looping around a second roller of said three rollers;
a third tilt cord, disposed to control said shaft, and looping around a third roller of said three rollers, said third tilt cord having its two ends terminating at said slide, said third cord forming a complete loop with said slide.

13. A blind control assembly for controlling both the height and tilt of a blind in an insulated window, comprising:
a plurality of rollers, each of said rollers having a axially through hole, each roller having an exterior surface with a predetermined friction;
a shaft inserted through the through hole of each roller, said shaft and said rollers being controllably rotatable in unison;
tilt cord means coupled to said rollers for controllably tilting said blind;
pull cord means coupled to said blind for controllably raising and lowering said blind;
a slide control coupled to said tilt cord means and said pull cord means, said slide control having at least one internal roller wheel, said slide control controllably moving in a first movement to activate said tilt cord means, said slide control controllably moving in a second movement to activate said pull cord means, said pull cord means being affixed to a stationary anchor through said at least one internal roller wheel.

14. The blind control assembly of claim 13, further comprising:
an external roller wheel, said tilt cord means coupled to said external roller and one of said rollers, for being controllably moved by the movement of said slide control;
a spring fixer connecting between a stationary spot and said external roller wheel.

15. The blind control assembly of claim 14, wherein said pull cord means comprises:
a first router, said first router supporting one of said rollers to allow said roller to rotate;
a second router, said second router support another one of said rollers to allow said roller to rotate;
a first cord, extending from distal end of said blind to said slide control through said first router;
a second cord, extending from proximate end of said blind to said slide control through said second router;
a third router, for routing said first and second cords down to said slide control.

16. The blind control assembly of claim 15, wherein said tilt cord means comprises:
a first tilt cord looping around a first roller and the edges of said blind at a distal end;
a second tilt cord looping around a second roller and the edges of said blind at a proximate end;
a third tilt cord looping around a third roller and said external roller, said third tilt cord having its two ends terminating at said slide, defining a complete loop.

17. A blind control assembly for controlling both the height and tilt of a blind in an insulated window, comprising:
tilt means for controllably tilting said blind, comprising a driving cord, a transmission and at least one driven cord coupled to said blind, said driving cord controllably driving said driven cord through said transmission;
pull means coupled to said blind for controllably raising and lowering said blind;
a slide control coupled to said tilt means and said pull means, said slide control controllably moving in a first movement to activate said driving cord, which drives said at least one driven cord through said transmission, said slide control controllably moving in a second movement to activate said pull means.

18. The blind control assembly of claim 17, further comprising:
an external roller wheel, said driving cord being wound around said external roller wheel to form a loop together with said slide control.

19. The blind control assembly of claim 18, further comprising:
a spring fixer connecting between a stationary spot and said external roller wheel.
